(19) United States
(12) Patent Application Publication
(10) Pub. No.: US 2020/0140281 A1
(43) Pub. Date: May 7, 2020

(54) METHOD FOR PRODUCING FIBERS AND FOAMS CONTAINING SILICON CARBIDE, AND USE THEREOF

(71) Applicant: PSC Technologies GmbH, Berlin (DE)

(72) Inventors: Siegmund GREULICH-WEBER, Bad Lippspringe (DE); Rüdiger SCHLEICHER-TAPPESER, Berlin (DE)

(73) Assignee: PSC Technologies GmbH, Berlin (DE)

(21) Appl. No.: 16/626,995

(22) PCT Filed: Jun. 25, 2018
(86) PCT No.: PCT/EP2018/066965

§ 371 Date: Dec. 27, 2019

(30) Foreign Application Priority Data
Jun. 27, 2017 (DE) 10 2017 114 243.6

(51) Int. Cl. C01B 32/963; H01M 4/58; C04B 35/622; C04B 35/626; C04B 38/00; C04B 41/87; C04B 41/50; H01M 10/0525; H01M 4/04

(52) U.S. Cl. CPC C01B 32/963; H01M 4/58; C04B 35/62281; C04B 35/62675; C04B 38/0029; B82Y 30/00; C04B 41/5059; H01M 10/0525; H01M 4/04; C01P 2004/10; C04B 41/87

(57) ABSTRACT

The present invention relates to a method for producing silicon carbide-containing fibers or silicon carbide-containing nano- and/or micro-structured foams, and to the use thereof, in particular as anode materials for lithium-ion storage batteries.

### CROSS-REFERENCES TO RELATED APPLICATIONS

This application is a National Stage filing of International Application PCT/EP 2018/066965, filed Jun. 25, 2018, entitled METHOD FOR PRODUCING FIBERS AND FOAMS CONTAINING SILICON CARBIDE, AND USE THEREOF, claiming priority to DE 10 2017 114 243.6, filed Jun. 27, 2017. The subject application claims priority to PCT/EP 2018/066965 and to DE 10 2017 114 243.6 and incorporates all by reference herein, in their entirety.

### BACKGROUND OF THE INVENTION

The present invention relates to the technical field of producing porous materials and accumulator technology.

In particular, the present invention relates to a process for producing silicon carbide-containing fibers and silicon carbide-containing nano- and/or microstructured foams.

Furthermore, the present invention relates to silicon carbide-containing fibers and silicon carbide-containing nano- or microstructured foams as well as their use as sealing and insulating materials or in composite materials and their use as electrode material or for the production of electrodes.

Furthermore, the present invention concerns an apparatus for producing silicon carbide-containing fibers and silicon carbide-containing nano- or micro-structured foams.

Furthermore, the present invention relates to a process for applying nano- or micro-structured silicon carbide foams to sheet materials, in particular for the production of electrodes which comprise nano- or micro-structured silicon carbide foams, as well as the electrodes obtainable by the inventive method and accumulators which contain said electrodes.

Finally, the present invention relates to an apparatus for applying nano- and/or micro-structured silicon carbide foams to sheet materials, in particular for producing electrodes which have nano- and/or microstructured silicon carbide foams.

Silicon carbide, with the chemical formula SiC, is an extremely interesting and versatile material in electrical engineering as well as for the production of ceramic materials. Due to its high hardness and high melting point, silicon carbide is also called carborundum and is often used as an abrasive or insulator in high-temperature reactors. In addition, silicon carbide forms alloys or alloy-like compounds with a number of elements and compounds, which have a number of advantageous material properties, such as high hardness, high resistance, low weight and low sensitivity to oxidation even at high temperatures.

Silicon carbide-containing materials are usually sintered at high temperatures, resulting in relatively porous bodies suitable only for a limited number of applications.

With the sintering processes usually carried out, only three-dimensional bodies can be produced in general. However, high-performance ceramic materials based on foams of silicon carbide alloys would be suitable for the production of thermally, chemically and mechanically extremely resistant, but at the same time very light materials, for example for spring systems, seals or suspensions. Fibers based on materials containing silicon carbide, in particular silicon carbide alloys, can also be used as reinforcing fillers in plastics or construction materials. So far, however, no processes are available that would allow simple and reproducible production of fibers based on silicon carbide or silicon carbide alloys.

In addition, electronic applications are of particular relevance, in particular semiconductor applications, since silicon carbide is mechanically and thermally extremely resistant and the electronic properties can be tailored to the respective application by suitable doping. Pure silicon carbide is an insulator, but due to its good thermal conductivity it is suitable as a substrate for semiconductor structures. By appropriate doping, in particular with the elements boron, aluminum, nitrogen and phosphorus, excellent (semi-)conductive materials can be provided, which can be used at temperatures up to 500° C.

In addition, silicon carbide is increasingly used as a material in the manufacture of electrodes, in particular anodes, for lithium ion accumulators.

State-of-the-art standard anode materials for lithium ion accumulators consist of an electrical discharge plate, for example a metal foil, which is coated with graphite particles for lithium ion storage. The graphite particles are usually distributed in a binder in order to obtain a robust coating. In order to increase the electrical conductivity of the binder and to enable current dissipation via the discharge plate, the binder additionally contains carbon black particles. However, the capacity of these anodes to store lithium ions is very limited.

In order to increase the storage capacity of the anode material for lithium ions—and thus the capacity of the accumulator—at least part of the graphite is often replaced by crystalline silicon or tin particles. Crystalline silicon and tin particles have significantly higher storage capacities for lithium ions than graphite, but are subject to a volume change of up to 400% when the lithium ions are absorbed and released. Due to this drastic volume change, the binder matrix, in which the silicon or tin particles are embedded, is destroyed in the course of the loading and unloading cycles, so that such anodes are not cycle-resistant, but their capacity decreases from cycle to cycle.

Silicon carbide offers the advantage over the materials graphite, silicon and tin, which are usually used as materials for lithium ion storage, that on the one hand it has significantly higher lithium ion storage capacities than, for example, graphite and on the other hand, it does not undergo any change in volume when lithium ions are absorbed and released, unlike silicon and tin.

Through the at least partial substitution of tin and silicon particles and also graphite by silicon carbide particles, it is possible to increase the cycle stability and the capacity of lithium ion accumulators.

Despite the obvious positive properties of silicon carbide as a material for anodes of lithium ion accumulators, the very costly and time-consuming production of silicon carbide impedes a wide and standard use of silicon carbide.

For example, the scientific publication Y. Zhao, W. Kang, L. Li, G. Yan, X. Wang, X. Zhuang, B. Cheng, “Solution Blown Silicon Carbide Porous Nanofiber Membrane as Electrode Materials for Supercapacitors”, Electrochimica Acta, 207, 2016, pages 257 to 265, describes the production of porous membranes from silicon carbide fibers obtained from polymer solutions containing polycarbosilanes and polystyrene by spinning and subsequent calcination.

Furthermore, WO 2016/078955 concerns a process for producing an electrode material for a battery electrode, in particular a lithium ion battery, wherein the electrode material comprises a nanostructured silicon carbide. The silicon carbide is obtained by gasification of precursor particles and deposited on a substrate. In particular, the rapid and complete gasification of the precursor particles is of great importance in this context, but is difficult to realize in practice, so that always larger amounts of undecomposed or only partially reacted precursor particles remain as waste material and have to be disposed of.

Beyond this, further processes for the production of crystalline silicon carbide particles are known. However, these crystalline silicon carbide particles often do not have a surface area sufficient to fully utilize the advantages of the silicon carbide, namely the rapid addition and removal of lithium ions and the high storage capacity for lithium ions.

Therefore, a simple and reproducible process for the production of porous silicon carbide-containing structures with high specific surfaces, which can be used for sealing and insulating materials or in composite materials, is still lacking. In particular, no simple and reproducible process for the production of porous silicon carbide structures is known which can be used as electrical materials, in particular anode materials, in lithium ion accumulators.

Moreover, it is usually only attempted to replace the graphite portion or the portion of silicon particles or tin particles in the anode materials of lithium ion accumulators with silicon carbide. This means that the anode materials still contain binders and conductivity improvers, such as carbon black particles, which, however, do not increase the storage capacity of the anode material.

To date, no process or material is known which makes it possible to reduce the binder content in the electrode material, in particular anode material, for lithium ion accumulators or to completely dispense with binders.

### BRIEF SUMMARY OF THE INVENTION

It is therefore an objective of the present invention to avoid or at least mitigate the disadvantages and problems associated with the state of the art described above.

In particular, one objective of the present invention is to provide a simple and reproducible method for the production of porous silicon carbide-containing structures, in particular silicon carbide structures, thus enabling an economically viable production of silicon carbide-containing materials.

In addition, a further objective of the present invention is to provide an improved electrode material, in particular anode material, for lithium ion accumulators.

Subject-matter of the present invention according to a first aspect of the present invention is thus a process for the production of silicon carbide-containing fibers and/or silicon carbide-containing nano- or microstructured silicon carbide foams.

Further subject-matter of the present invention according to a second aspect of the present invention are silicon carbide-containing fibers.

Again, further subject-matter of the present invention according to a third aspect of the present invention is the use of silicon carbide-containing fibers.

Another subject-matter of the present invention according to a fourth aspect of the present invention is the use of silicon carbide fibers for the manufacture of anodes and/or as the anode material.

Furthermore, subject-matter of the present invention according to a fifth aspect of the present invention are silicon carbide-containing nano- and/or microstructured foams.

Again, another subject-matter of the present invention according to a sixth aspect of the present invention is the use of silicon carbide-containing nano- and/or microstructured foams.

Further subject-matter of the present invention according to a seventh aspect of the present invention is the use of silicon carbide-containing nano- and/or microstructured foams, in particular nano- and/or microstructured silicon carbide foams, for producing anodes and/or anode materials.

Furthermore, in accordance with an eighth aspect of the present invention, subject-matter of the present invention is an apparatus for the production of silicon carbide-containing fibers or silicon carbide-containing nano- and/or micro-structured foams.

Further subject matter of the present invention according to a ninth aspect of the present invention is a method for the application of a surface structure.

Another subject-matter of the present invention according to a tenth and an eleventh aspect of the present invention is an electrode.

Again, another subject-matter of the present invention according to a thirteenth aspect of the present invention is a lithium ion accumulator.

Finally, a further subject-matter of the present invention—according to a fourteenth aspect of the present invention—is an apparatus for applying a sheet material, in particular for producing an electrode.

It goes without saying that the particular features mentioned in the following, in particular special embodiments or the like, which are only described in relation to one aspect of the invention, also apply in relation to the other aspects of the invention, without this requiring any express mention.

Furthermore, for all relative or percentage, in particular weight-related, quantities or amounts stated below, it is to be noted that, within the framework of this invention, these are to be selected by the person skilled in the art in such a way that the sum of the ingredients, additives or auxiliary substances or the like always results in 100 percent or 100 percent by weight. This, however, goes without saying for the person skilled in the art.

In addition, all of the parameters specified below or the like can be determined by standardized or explicitly specified determination methods or by common determination methods known per se by the person skilled in the art.

### BRIEF DESCRIPTION OF THE DRAWINGS

FIG. 1: provides an inventive apparatus for producing silicon carbide-containing fibers or silicon carbide-containing nano- and/or micro-structured foams,

FIG. 2: provides an apparatus according to the invention for applying nano- and/or microstructured silicon carbide foams to surface structures,

FIG. 3: provides an image of a nano- and/or microstructured silicon carbide foam in 100× magnification, and

FIG. 4: provides an image of a nano- and/or microstructured silicon carbide foam at 35,000× magnification.

### DETAILED DESCRIPTION OF THE INVENTION

With this provision made, the subject-matter of the present invention is explained in more detail in the following.

The subject-matter of the present invention—according to a first aspect of the present invention—is thus a method for producing silicon carbide-containing fibers or silicon carbide-containing nano- and/or micro-structured foams, wherein
(a) liquid and/or gaseous precursors containing at least one carbon source and at least one silicon source are introduced into a first zone, in particular a first temperature zone, of a reactor and heated to temperatures in the range from 1,100 to 2,100° C. so that the precursors are decomposed, and
(b) in a second zone, in particular in a second temperature zone, of the reactor, silicon carbide-containing fibers or silicon carbide-containing nano- and/or microstructured foams are deposited on a substrate.

For, as was surprisingly found, the use of gaseous or liquid precursors in a gas-phase reaction can produce silicon carbide-containing fibers or silicon carbide-containing nano- and/or microstructured foams, whereby the deposition reaction is highly selective and takes place without any side reaction, in particular without solid waste materials.

In particular, when liquid or gaseous precursors are used, an almost complete conversion of the precursors used can be achieved. This is a clear improvement over the previously known state of the art methods based on the gasification of solids. The decomposition of solids, in particular precursor granulates, usually leaves behind an unreacted or only partially decomposed residue, which must be disposed of.

The process according to the invention allows in particular the targeted preparation of silicon carbide-containing fibers or silicon carbide-containing foams, as explained below. In particular, the method according to the invention enables the targeted production of silicon carbide-containing fibers or foams on the basis of a large number of silicon carbide-containing compounds, such as silicon carbide, doped silicon carbide, non-stoichiometric silicon carbide or silicon carbide alloys.

The inventive process thus enables a particularly efficient and reproducible production of silicon carbide-containing fibers or silicon carbide-containing nano- and/or microstructured foams at economically favorable conditions.

With the inventive method, both fibers and foams based on silicon carbide alloys with excellent mechanical properties and high thermal load-bearing capacity as well as optionally doped silicon carbide fibers and silicon carbide foams for applications in electrical engineering and battery technology are available.

The fibers and nano- or microstructured foams based on doped silicon carbide accessible by the inventive method are suited excellently as storage materials for lithium ions in lithium ion accumulators. The silicon carbide fibers or nano- and/or micro-structured silicon carbide foams produced according to the inventive process can be used either in the form of mixtures with binders as electrode material, in particular anode material, in accumulators or, in the case of nano- and/or micro-structured silicon carbide foams, also directly as electrode material, in particular anode material, i.e. without the use of further binders.

Through the use of nano- and/or microstructured silicon carbide foams, which have a high porosity, the electrolytes in a lithium ion accumulator can completely penetrate the silicon carbide foam, so that the theoretical storage capacity of the silicon carbide can be fully exploited and the lithium ions can be absorbed and released very quickly.

A silicon carbide-containing fiber and/or a silicon carbide-containing foam, in the context of the present invention, means fibers and/or foams of silicon carbide-containing compounds, i.e. of a binary, ternary or quaternary inorganic compound, the empirical formula of which contains silicon and carbon. In particular, a compound containing silicon carbide does not contain molecularly bound carbon, such as carbon monoxide or carbon dioxide; rather, the carbon is present in a solid structure. Usually the silicon carbide-containing compound, in particular of the fibers and/or foams, is selected from silicon carbide, non-stoichiometric silicon carbides, doped silicon carbides and silicon carbide alloys.

In the context of the present invention, a non-stoichiometric silicon carbide is defined as a silicon carbide which does not contain carbon and silicon in a molar ratio of 1:1, but in different proportions. Usually, a non-stoichiometric silicon carbide in the context of the present invention shows a molar excess of silicon.

A doped silicon carbide is a silicon carbide which contains silicon and carbon either in stoichiometric or non-stoichiometric quantities, but which is mixed, in particular doped, with further elements, in particular from the 13th and 15th group of the Periodic Table of the Elements, in small quantities. The doping of the silicon carbides has a decisive influence on the electrical properties of the silicon carbides in particular, so that doped silicon carbides are particularly suitable for applications in semiconductor technology. In the context of the present invention, a doped silicon carbide is preferably a stoichiometric silicon carbide of the chemical formula SiC, which has at least one doping element in the ppm (parts per milli-on) or ppb (parts per billion) range.

In the context of this invention, silicon carbide alloys are compounds of silicon carbide with metals such as titanium or other compounds such as zirconium carbide or boron nitride, which contain silicon carbide in different and strongly varying proportions. Silicon carbide alloys often form high-performance ceramics, which are characterized by special hardness and temperature resistance.

The inventive method is thus suitable for the production of fibers and foams from different silicon carbide-containing materials, which can be used for a wide range of applications—from sealing and insulating materials to composite materials and materials for electrical and electronic applications.

In the context of this invention, a precursor is a chemical compound or a mixture of chemical compounds which reacts by chemical reaction and/or by the action of energy, in particular heat, to form one or more target compounds. In particular, within the framework of the present invention, a precursor may also be a solution or dispersion of chemical compounds which react under process conditions to the target compounds; this special configuration of the precursor is hereinafter also referred to as precursor sol.

In the context of this invention, a silicon source or a carbon source is understood to mean compounds which can release silicon or carbon under process conditions such that silicon carbide or, in the presence of doping and/or alloying reagents or elements, a doped silicon carbide or a silicon carbide alloy is formed. In this context, silicon and carbon do not have to be released in elementary form, but it is sufficient if the released reactive compounds react under process conditions to silicon carbide or silicon carbide alloys. The silicon source, the carbon source and, if necessary, the doping and/or alloying reagents can be either directly gaseous or liquid precursor compounds in particular, or their reaction products, if the precursor is in the form of a precursor sol for example, as described below.

In the context of the present invention, liquid and/or gaseous precursors are understood to mean that these are present in liquid and/or gaseous form before and immediately upon introduction into the reactor. The precursors transfer into the gas phase as immediately as possible after introduction into the reactor and react there to the corresponding silicon carbide-containing materials or fibers and foams under decomposition and release of reactive species.

In the context of the present invention, a substrate is the surface on which the silicon carbide-containing fibers or the silicon carbide-containing nano- and/or microstructured foams are deposited. In particular, a substrate in the context of this invention means both a pure deposition surface for fibers and foams, which are subsequently removed from the surface, and a material to be coated.

As explained above, the process according to the invention can be used to produce either isolated, i.e. separated, silicon carbide-containing fibers or foams with crosslinked silicon carbide-containing fibers.

In the context of this invention, silicon carbide-containing nano- and/or microstructured foams are particularly considered to be three-dimensional, highly porous network structures made of silicon carbide-containing fibers. The silicon carbide-containing nano- and/or microstructured foams are porous open-cell foams, which are highly permeable in particular for liquids and can therefore be used in an excellent way as electrode material for accumulators. In addition, the silicon carbide-containing foams can also be used as sealing and insulating materials, for example for damping or absorption of vibration and sound.

In the context of this invention, it is therefore usually intended that the nano- and/or microstructured silicon carbide-containing foams are composed of interconnected, in particular cross-linked, silicon carbide-containing fibers, preferably are three-dimensional networks of silicon carbide-containing fibers. In this context, nanostructured is understood to mean that the individual silicon carbide-containing fibers create pores in the three-dimensional structure with expansion in the nanometer range. In the context of this invention, the term microstructured means that pores are created in the silicon carbide-containing structure by the silicon carbide-containing fibers, the expansion of which lies in the micrometer range.

In the context of this invention, it is advantageously intended that the silicon carbide-containing nano- and/or microstructured foams are deposited on the substrate with a layer thickness of 0.5 μm to 15 mm, in particular 0.8 μm to 12 mm, preferably 1 μm to 10 mm. Silicon carbide foams with the aforementioned thicknesses are excellently suited as anode material for lithium ion accumulators and exhibit in particular very good lithium ion storage capacities, while foams based on silicon carbide alloys or non-stoichiometric silicon carbides can be used particularly well for insulating and sealing purposes or for suspensions.

In the context of the present invention, it is also usually intended that the silicon carbide-containing fibers of the silicon carbide-containing nano- and/or microstructured foams have an aspect ratio of greater than 3, in particular greater than 10, preferably greater than 100.

Likewise, the present invention may provide that the silicon carbide-containing fibers of the silicon carbide-containing nano- and/or microstructured foams have diameters in the range of 5 nm to 5 μm, in particular 10 nm to 2 μm.

Furthermore, particularly good results are obtained if the silicon carbide-containing fibers of the silicon carbide-containing nano- and/or microstructured foams have lengths in the range of 5 nm to 10 μm, in particular 5 nm to 1 μm, preferably 5 nm to 500 μm.

As far as the dimensioning of the separate silicon carbide-containing fibers is concerned, this is similar to that of the silicon carbide-containing fibers in the silicon carbide-containing nano- and/or microstructured foams.

In the context of this invention it is usually intended that the silicon carbide-containing fibers have an aspect ratio of greater than 3, in particular greater than 10, preferably greater than 100.

Likewise, the present invention may provide that the silicon carbide-containing fibers have diameters in the range of 5 nm to 5 μm, in particular 10 nm to 2 μm.

In addition, it may be provided that the silicon carbide-containing fibers have lengths in the range 100 nm to 30 mm, in particular 500 nm to 10 mm, preferably 1 μm to 5 mm.

According to a preferred embodiment of the present invention, the silicon carbide-containing fibers and the silicon carbide-containing nano- and/or microstructured foams consist of optionally doped nanocrystalline or monocrystalline, in particular nanocrystalline, silicon carbide. The excellent electrical properties of silicon carbide, in particular doped silicon carbide, are only effective if the silicon carbide is in crystalline form, in particular in monocrystalline or at least nanocrystalline form.

The silicon carbide is present in the silicon carbide fibers and the silicon carbide foams preferably as cubic polytype 3C—SiC or in the form of hexagonal polytypes 4H—SiC and 6HSiC.

Silicon carbide-containing materials of nanocrystalline or monocrystalline silicon carbide, which may be doped, are particularly suitable for use in electrical engineering, in particular, for example, in batteries.

According to an equally preferred embodiment of the present invention, the silicon carbide-containing fibers and the silicon carbide-containing nano- and microstructured foams consist of nanocrystalline or monocrystalline, in particular nanocrystalline, non-stoichiometric silicon carbide or nanocrystalline or monocrystalline, in particular nanocrystalline, silicon carbide alloys. Non-stoichiometric silicon carbides and silicon carbide alloys are suitable for the production of particularly resilient and resistant materials, which can withstand even extreme stresses due to high temperatures, chemicals and mechanical stress.

As already mentioned above, the silicon carbide can be doped within the scope of this invention.

Usually the silicon carbide is doped with an element selected from the group of nitrogen, phosphorus, arsenic, antimony, boron, aluminum, gallium, indium and mixtures thereof.

If the silicon carbide is doped in the context of the present invention, it has proven advantageous if the doped silicon carbide contains the doping element in quantities of 0.000001 to 0.0005 wt. %, in particular 0.000001 to 0.0001 wt %, preferably 0.000005 to 0.0001 wt %, more preferably 0.000005 to 0.00005 wt. %, based on the doped silicon carbide. For the targeted adjustment of the electrical properties of the silicon carbide, extremely small amounts of doping elements are therefore completely sufficient.

If a non-stoichiometric silicon carbide is produced within the scope of the present invention, the non-stoichiometric silicon carbide is usually a silicon carbide of the general formula (I)

SiC₁₋ₓ (I)

with
x=0.05 to 0.8, in particular 0.07 to 0.5, preferably 0.09 to 0.4, more preferably 0.1 to 0.3.

Such silicon-rich silicon carbides have a particularly high mechanical strength and are suitable for a variety of applications as ceramics, in particular as reinforcing fillers in composite materials.

In the context of the present invention, it may also be provided that the non-stoichiometric silicon carbide is doped, in particular with the aforementioned elements.

If the silicon carbide-containing fibers or the silicon carbide-containing nano- and/or microstructured foams contain or consist of silicon carbide alloys in the context of the present invention, the silicon carbide alloy is usually selected from MAX phases, alloys of silicon carbide with elements, in particular metals, and alloys of silicon carbide with metal carbides and/or metal nitrides. Such silicon carbide alloys contain silicon carbide in varying and strongly fluctuating proportions. In particular, silicon carbide may be the main component of the alloys. However, it is also possible that the silicon carbide alloy contains only small amounts of silicon carbide.

Usually the silicon carbide alloy contains the silicon carbide in quantities of 10 to 95 wt %, in particular 15 to 90 wt. %, preferably 20 to 80 wt %, based on the silicon carbide alloy.

In the context of this invention, MAX phases are in particular carbides and nitrides crystallizing in hexagonal layers of the general formula Mₙ₊1AXₙ with n=1 to 3. M represents an early transition metal from the third to sixth group of the Periodic Table of the Elements, while A represents an element from the 13th to 16th group of the Periodic Table of the Elements. X is either carbon or nitrogen. In the context of this invention, however, only such MAX phases are of interest whose empirical formula contains silicon carbide (SiC), i.e. silicon and carbon.

MAX phases often exhibit unusual combinations of chemical, physical, electrical and mechanical properties because they exhibit both metallic and ceramic behavior depending on the conditions. This includes, for example, high electrical and thermal conductivity, high resistance to thermal shock, very high hardness and low coefficients of thermal expansion.

If the silicon carbide alloy is a MAX phase, it is preferred if the MAX phase is selected from Ti₄SiC₃ and Ti₃SiC.

In addition to the properties already described, the MAX phases mentioned above in particular are highly resistant to chemicals and oxidation at high temperatures.

If the material of the silicon carbide-containing fibers and/or the silicon carbide-containing nano- or microstructured foams is an alloy of silicon carbide, it has been proven suitable if the alloy is selected from alloys of silicon carbide with metals from the group of Al, Ti, V, Cr, Mn, Co, Ni, Zn, Zr and mixtures thereof.

If the alloy of silicon carbide is selected from alloys of silicon carbide with metal carbides and/or nitrides, it has been proven effective if the alloys of silicon carbide with metal carbides and/or nitrides are selected from the group of boron carbides, in particular B₄C, chromium carbides, in particular Cr₂C₃, titanium carbides, in particular TiC, molybdenum carbides, in particular Mo₂C, niobium carbides, in particular NbC, tantalum carbides, in particular TaC, vanadium carbides, in particular VC, zirconium carbides, in particular ZrC, tungsten carbides, in particular WC, boron nitride, in particular BN, and mixtures thereof.

Regarding the temperatures during the production of the silicon carbide-containing fibers and/or nano- or microstructured foams, the present invention may provide that the temperature in the first zone of the reactor is adjusted in the range from 1,200 to 2,000° C., in particular from 1,300 to 1,900° C.

In the context of the present invention, it is advantageously provided that a temperature gradient is present in the reactor, in particular between the first and second zone of the reactor, at least regionally.

Likewise, it may be provided within the scope of the present invention that the temperature in the second zone of the reactor is lower than in the first zone of the reactor. The first zone, in particular the first temperature zone, of the reactor usually begins in the area in which the gaseous or liquid precursors are introduced into the reactor and occupies at least half of the reactor volume. In this area, the precursors are decomposed into reactive species, which then enter the second zone, in particular the second temperature zone, in which usually a slightly lower temperature prevails, so that the first condensates of the reactive species are formed. Then, the deposition of the silicon carbide-containing material, in particular in the form of foams or from each other separated fibers, takes place on the substrate.

According to another preferred embodiment of the present invention, the temperature of the substrate is lowered again compared to the temperature in the second zone, in particular the second temperature zone of the reactor. In particular, this ensures that the silicon carbide-containing fibers or foams are formed exclusively on the substrate and are not deposited elsewhere in the reactor, e.g. on the reactor walls.

Within the framework of the present invention, it may be provided that the temperature in the second zone of the reactor is set to at least 30° C., in particular at least 40° C., preferably at least 50° C., lower than in the first zone of the reactor.

Likewise, it may be provided that the temperature in the second zone of the reactor is not higher than 300° C., in particular not higher than 250° C., preferably not higher than 200° C., than in the first zone of the reactor.

In accordance with a preferred embodiment of the present invention, it is envisaged that the temperature in the second zone of the reactor is set to 30 to 300° C., in particular 40 to 250° C., preferably 50 to 200° C., lower than in the first zone of the reactor.

The present invention may provide for the temperature in the second zone of the reactor to be set in the range from 1,000 to 2,000° C., in particular 1,050 to 1,900° C., preferably 1,100 to 1,800° C.

As far as the heating of the precursors in the first zone is concerned, this can be done in many different ways. However, it has proven advantageous if the precursors are heated by electromagnetic radiation, in particular infrared radiation and/or microwave radiation, and/or an electric heater. Particularly good results are obtained in this context when the precursors are heated by microwave radiation and/or electrical resistance heating.

In the context of this invention, it is generally provided that precursors are selected from mixtures of liquid and/or gaseous carbon and silicon sources and solutions or dispersions containing carbon and silicon sources, in particular SiC precursor sols, and mixtures thereof.

The present invention may therefore provide for the use of either mixtures of liquid and/or gaseous carbon and silicon sources, i.e. compounds which release carbon or silicon or reactive intermediates under reaction conditions, or liquid solutions or dispersions comprising the carbon and silicon sources.

If liquid and/or gaseous carbon sources are used as precursors in the present invention, the liquid and/or gaseous carbon source may be selected from alkanes, amines, alkyl halides, aldehydes, ketones, carboxylic acids, amides, carboxylic acid esters and mixtures thereof, in particular C1- to C8-alkanes, primary and secondary C1- to C4-alkylamines, C1- to C8-alkyl halides, C1- to C8-aldehydes, C1- to C8-ketones, C1- to C8-carboxylic acids, C1- to C8-amides, C1- to C8-carboxylic acid esters and mixtures thereof.

Particularly good results are obtained in this context if the gaseous and/or liquid carbon source is selected from C1- to C8-alkanes, in particular C1- to C4-alkanes, and mixtures thereof. In the context of this invention, it is therefore preferred if the gaseous or liquid carbon source is a short-chain and therefore volatile alkane. Particularly when using oxygen-containing functional groups, care must be taken to ensure that the excess of carbon is so high that carbon is always oxidized to carbon monoxide or carbon dioxide and that silicon is not oxidized to silicon dioxide or that silicon dioxide is immediately reduced again by carbon, since silicon dioxide would considerably disrupt the structure and function of the silicon carbide-containing fibers or foams.

In the context of the present invention, it has also proven advantageous if the liquid and/or gaseous silicon source is selected from silanes, siloxanes and their mixtures, preferably silanes.

If siloxanes are used as precursors in the context of the present invention, it is possible that the siloxane or siloxanes represent both the carbon source and the silicon source if suitable siloxanes are selected so that no further precursors need to be used with the exception of possible doping reagents.

If in the context of the present invention a siloxane is used as a liquid and/or gaseous silicon source, it has proven advantageous if the siloxane is selected from alkyl and phenylsiloxanes, in particular methyl and phenylsiloxanes.

Likewise, very good results are obtained if the siloxane has a weight average molecular weight in the range from 500 to 5,000 g/mol, in particular 750 to 4,000 g/mol, preferably 1,000 to 2,000 g/mol.

In the context of this invention, however, it is particularly preferred if the silicon source is a silane. Silanes are often highly volatile compounds which quickly pass into the gas phase and react residue-free or can be decomposed easily, respectively.

Particularly good results are obtained in the context of the present invention if the silane is selected from monosilane (SiH₄), halosilanes, alkylsilanes, alkoxysilanes and mixtures thereof.

In particular, very good results are obtained when a silane of general formula (I)

R¹₄₋ₙSiR²ₙ (I)

with
R¹, R² alkyl, in particular C1- to C5-alkyl, preferably C1- to C3-alkyl, more preferably C1- and/or C2-alkyl;
Aryl, in particular C6- to C20-aryl, preferably C6- to C15-aryl, more preferably C6- to C10-aryl;
Olefin, in particular terminal olefin, preferably C2- to C10-olefin, more preferably C2- to C8-olefin, particularly preferably C2- to C5-olefin, preferentially C2- and/or C3-olefin, particularly preferentially vinyl;
   Halogenide, in particular chloride and/or bromide;
      Alkoxy, in particular C1- to C6-alkoxy, preferably C1- to C4-alkoxy, more preferably C1- and/or C2-alkoxy; and
      n=1-4,
      is used.

In this context it is preferred if the silane is selected from SiH₄, SiCl₄, Si(CH₃)₄, Si(OCH₃)₄, Si(OCH₂CH₃)₄ and mixtures thereof.

In addition, the present invention may provide that the precursors, in particular the mixture of gaseous and/or liquid carbon and silicon sources, further comprise at least one doping reagent. Liquid and/or gaseous doping reagents, in particular, are advantageous as doping reagents in accordance with this embodiment of the present invention. In particular, compounds of the elements of the 13th and 15th groups of the Periodic Table of the Elements can be used as doping reagents. According to a preferred embodiment of the present invention, the doping reagent is a liquid or gaseous compound of an element selected from the group consisting of boron, aluminum, gallium, indium, nitrogen, phosphorus, arsenic, antimony, bismuth and mixtures thereof. The hydrides, i.e. hydrogen compounds, and organyls, i.e. methyl compounds, of the aforementioned doping elements are particularly suitable. However, solutions, in particular liquid solutions of salts of the aforementioned compounds, can also be used as doping reagents, which are described in more detail below.

Furthermore, the present invention may also provide that the precursors, in particular the mixture of gaseous and/or liquid carbon or silicon sources, further contain at least one alloying reagent, preferably for producing silicon carbide alloys. As already mentioned in connection with the doping reagents, gaseous and/or liquid alloying reagents in particular are advantageous as alloying reagents according to this embodiment, whereby in particular volatile compounds of the aforementioned metals can be used. The alloying reagent is preferably a liquid, gaseous and/or volatile compound selected from the group consisting of Al, Ti, V, Cr, Mn, Co, Ni, Zn, Zr and mixtures thereof. The hydrides and organyls, in particular methyl compounds, of the metals mentioned above are particularly suitable as conductive alloying reagents in this context. As alloying reagents, however, solutions, in particular liquid solutions of salts of the aforementioned metals can also be used, which are also described in more detail below.

According to an equally preferred embodiment of the present invention, precursors are available in the form of solutions or dispersions containing carbon sources and silicon sources, in particular in the form of precursor sols.

In the context of the present invention, a precursor sol is a solution or dispersion of precursor substances, in particular starting compounds, which react to the desired target compounds. In precursor sols, the chemical compounds or mixtures of chemical compounds are no longer necessarily present in the form of the chemical compounds originally used, but as hydrolysis, condensation or other reaction or intermediate products, for example. This is, however, also illustrated by the expression “sol”. In sol-gel processes, inorganic materials are usually converted by hydrolysis or solvolysis into reactive intermediates or agglomerates and particles, the so-called sol, which then age into a gel, particularly through condensation reactions, whereby larger particles and agglomerates are formed in the solution or dispersion.

In the context of this invention, a SiC precursor sol is understood to be both a sol and a gel, in particular a solution or dispersion, which contains chemical compounds or their reaction products from which silicon carbide-containing materials can be obtained under process conditions.

In the context of this invention, a solution is understood to be a usually liquid single-phase system in which at least one substance, in particular a compound or its components, such as ions, are homogeneously distributed in another substance, the so-called solvent. In the context of the present invention, a dispersion is to be understood as an at least two-phase system, whereby a first phase, namely the dispersed phase, is distributed in a second phase, the continuous phase. The continuous phase is also known as the dispersion medium; the continuous phase is usually in the form of a liquid according to the present invention and dispersions are generally solid-liquid dispersions according to the present invention. In particular, as with polymeric compounds, the transition from a solution to a dispersion is often fluent in soles and gels and no clear distinction can be made between a solution and a dispersion anymore.

According to a preferred embodiment of the present invention, the solution or dispersion containing the carbon and silicon sources, in particular the precursor sol, contains,
(A) at least one silicon-containing compound,
(B) at least one carbon-containing compound,
(C) at least one solvent or dispersant; and
(D) optionally, doping and/or alloying reagents.

In the context of the present invention, the carbon- and silicon-source-containing solution or dispersion, in particular the SiC precursor sol, contains compounds which release silicon under process conditions and compounds which release carbon under process conditions. In this way, the ratio of carbon to silicon in the carbon- and silicon-source containing solutions or dispersions can be easily varied and tailored to the respective application. The silicon-containing or carbon-containing compounds according to this embodiment of the present invention correspond to carbon sources and silicon sources as previously defined.

In addition, the compounds used should have sufficiently high solubilities in the solvents used, in particular in ethanol and/or water, in order to be able to form fine dispersions or solutions, in particular sols, and should not react with other constituents of the solution or dispersion, in particular sol, to form insoluble compounds during the production process.

In addition, the reaction rate of the individual reactions should be adjusted to each other, since hydrolysis, condensation and, if necessary, gelation should take place undisturbed if possible, in order to achieve a homogeneous distribution of the individual components in the sol. The reaction products formed still should not be sensitive to oxidation and should not be volatile.

As far as the selection of the solvent or dispersion agent in the carbon- and silicon-source containing solution or dispersion is concerned, this can be selected from all suitable solvents or dispersion agents. Usually, however, the solvent or dispersion agent is selected from water and organic solvents and their mixtures. In particular in mixtures containing water, the usually hydrolysable or soluble starting compounds are converted to inorganic hydroxides, in particular metal hydroxides and silicas, which then condense so that precursors suitable for pyrolysis and crystallization are obtained.

In the context of this invention, it may be provided that the organic solvent is selected from alcohols, in particular methanol, ethanol, 2-propanol, acetone, ethyl acetate and mixtures thereof. It is particularly preferred in this context if the organic solvent is selected from methanol, ethanol, 2-propanol and mixtures thereof, with ethanol being preferred in particular.

The organic solvents mentioned above can be mixed with water in a wide range and are particularly suitable for dispersing or dissolving polar inorganic substances such as metal salts.

As explained above, the present invention uses mixtures of water and at least one organic solvent, in particular mixtures of water and ethanol, preferably as solvents or dispersants. In this context, it is preferred if the solvent or dispersant has a weight ratio of water to organic solvent of 1:10 to 20:1, in particular 1:5 to 15:1, preferably 1:2 to 10:1, more preferably 1:1 to 5:1, particularly 1:3. The ratio of water to organic solvents can be used on the one hand to adjust the hydrolysis rate, in particular of the silicon-containing compound and the doping reagents, and on the other hand to adjust the solubility and reaction rate of the carbon-containing compound, in particular of the carbon-containing precursor compound, such as sugar.

The quantity in which the composition contains the solvent or dispersant can vary widely depending on the respective application conditions and the type of doped or undoped silicon carbide to be produced or the non-stoichiometric silicon carbide or silicon carbide alloy. Usually, however, the composition comprises the solvent or dispersant in quantities of 10 to 80 wt. %, in particular 15 to 75 wt. %, preferably 20 to 70 wt %, more preferably 20 to 65 wt. %, based on the composition.

As far as the silicon-containing compound is concerned, it is preferred if the silicon-containing compound is selected from silanes, silane hydrolysates, orthosilicic acid and mixtures thereof, in particular silanes. In the context of this invention, orthosilicic acid and its condensation products can be obtained, for example, from alkali silicates whose alkali metal ions have been exchanged for protons by ion exchange. If possible, alkali metal compounds are not used in the composition of the present invention, since these are also incorporated into the silicon carbide-containing compound. As a rule, an alkali metal doping is not desired in the context of the present invention. However, if this should be desired, suitable alkali metal salts, for example of silicon-containing compounds or also alkali phosphates, can be used.

If a silane is used as a silicon-containing compound in the context of the present invention, it has proven successful if the silane is selected from silanes of the general formula II

R₄₋ₙSiXₙ (II)

with
R=Alkyl, in particular C1- to C5-alkyl, preferably C1- to C3-alkyl, more preferably C1- and/or C2-alkyl;
Aryl, in particular C6- to C20-aryl, preferably C6- to C15-aryl, more preferably C6- to C10-aryl;
Olefin, in particular terminal olefin, preferably C2- to C10-olefin, more preferably C2- to C8-olefin, particularly preferably C2- to C5-olefin, preferentially C2- and/or C3-olefin, particularly preferentially vinyl;
Amine, in particular C2- to C10-amine, preferably C2- to C8-amine, more preferably C2- to C5-amine, particularly preferably C2- and/or C3-amine;
Carboxylic acid, in particular C2- to C10-carboxylic acid, preferably C2- to C8-carboxylic acid, more preferably C2- to C5-carboxylic acid, particularly preferably C2- and/or C3-carboxylic acid;
Alcohol, in particular C2- to C10-alcohol, preferably C2- to C8-alcohol, more preferably C2- to C5-alcohol, particularly preferably C2- and/or C3-alcohol;
X=Halide, in particular chloride and/or bromide;
Alkoxy, in particular C1- to C6-alkoxy, preferably C1- to C4-alkoxy, more preferably C1- and/or C2-alkoxy; and
n=1-4, in particular 3 or 4.
Particularly good results are obtained, however, when the silane is selected from silanes of the general formula IIa

R₄₋ₙSiXₙ (IIa)

with
R═C1- to C3-alkyl, in particular C1- and/or C2-alkyl;
C6- to C15-aryl, in particular C6- to C10-aryl;
C2- and/or C3-olefin, in particular vinyl;
   X=alkoxy, in particular C1- to C6-alkoxy, preferably C1- to C4-alkoxy, more preferably C1- and/or C2-alkoxy; and
   n=3 or 4.

By hydrolysis and subsequent condensation reaction of the aforementioned silanes, condensed orthosilicic acids or siloxanes can easily be obtained within the scope of the present invention. These have only very small particle sizes, whereby further elements, in particular metal hydroxides, can also be incorporated into the basic structure.

Particularly good results are obtained in the context of the present invention when the silicon-containing compound is selected from tetraalkoxysilanes, trialkoxysilanes and their mixtures, preferably tetraethoxysilane, tetramethoxysilane or triethoxymethylsilane and their mixtures.

As far as the quantities in which the carbon- and silicon-source containing solution or dispersion contains the silicon-containing compound are concerned, this may also vary widely depending on the respective application conditions. Usually, however, the carbon- and silicon-source containing solution or dispersion contains the silicon-containing compound in quantities of 1 to 80% by weight, in particular 2 to 70% by weight, preferably 5 to 60% by weight, more preferably 10 to 60% by weight, based on the solution or dispersion.

As stated above, according to the invention, the carbon- and silicon-source containing solution or dispersion contains at least one carbon-containing compound. All compounds which can either be dissolved in the solvents used or at least finely dispersed and which can release solid carbon during pyrolysis can be considered as carbon-containing compounds. The carbon-containing compound is also preferably able to reduce metal hydroxides to elemental metal under process conditions.

In the context of the present invention, it has proven reliable if the carbon-containing compound is selected from the group of sugars, in particular sucrose, glucose, fructose, invert sugar, maltose; starch; starch derivatives; organic polymers, in particular phenol-formaldehyde resin and resorcinol-formaldehyde resin, and mixtures thereof.

Particularly good results are obtained in the context of the present invention when the carbon-containing compound is selected from the group of sugars; starch, starch derivatives and mixtures thereof, preferably sugars.

As far as the quantity in which the carbon-containing compound is contained in the carbon- and silicon-source containing solution or dispersion is concerned, this may also vary widely depending on the respective application and application conditions or the target compounds to be produced. Usually, however, the solution or dispersion contains the carbon-containing compound in quantities of 5 to 50 wt %, in particular 10 to 40 wt. %, preferably 10 to 35 wt. %, more preferably 12 to 30 wt. %, based on the solution or dispersion.

In the context of the present invention, the composition may contain a doping or alloying reagent. If the composition comprises a doping or alloying reagent, the composition usually comprises the doping or alloying reagent in quantities of 0.000001 to 60 wt %, in particular 0.000001 to 45 wt. %, preferably 0.000005 to 45 wt. %, more preferably 0.00001 to 40 wt. %, based on the solution or dispersion. The properties of the resulting silicon carbide-containing compounds can be decisively changed by the addition of doping and alloying reagents. Doping influences in particular the electrical properties of the silicon carbide-containing compound, whereas the mechanical and thermal properties of the silicon carbide-containing compounds are decisively influenced by the production of silicon carbide alloys or non-stoichiometric silicon carbides.

As already explained above, the contents of the individual components of the composition according to the invention vary widely depending on the respective application conditions and the silicon carbide-containing compounds to be produced. This results in large differences, for example, whether a stoichiometric, optionally doped, silicon carbide, a non-stoichiometric silicon carbide or a silicon carbide alloy is to be produced.

If the silicon carbide is to be doped, suitable doping reagents can be added to the solution or dispersion, in particular the precursor sol.

In this context, it is preferable to ensure that the doping reagents—as well as the alloying reagents—are decomposed or cleaved during the process in such a way that the desired elements react as reactive particles to the desired optionally doped silicon carbide, while the remaining constituents of the compound react as far as possible to stable gaseous substances, such as water, CO, CO₂, HCl etc., which can be easily removed via the gas phase. In addition, the compounds used should have sufficiently high solubilities in the solvents used, in particular in ethanol and/or water, to be able to form finely divided dispersions or solutions, in particular sols, and should not react with other constituents of the solution or dispersion, in particular sol, to form insoluble compounds during the manufacturing process.

If the silicon carbide is to be doped with nitrogen, nitric acid, ammonium chloride or melamine, for example, may be used as doping reagents. In the case of nitrogen, it is also possible to carry out the method for producing the silicon carbide in a nitrogen atmosphere, which can also achieve doping with nitrogen, but with less precision.

In addition, doping with alkali metal nitrates, for example, can also be achieved. However, due to the alkali metals which remain in the precursor granulate such doping is less preferred.

If a doping with phosphorus is to be carried out, it has proven to be advantageous if a doping with phosphoric acid is carried out

If doping with arsenic or antimony is to be carried out, it has proven advantageous if the doping reagent is selected from arsenic trichloride, antimony chloride, arsenic oxide or antimony oxide.

If aluminum is to be used as a doping element, aluminum powder can be used as a doping reagent, in particular for acid or basic pH values. In addition, it is also possible to use aluminum chlorides. In general, when using metals as doping elements, it is always possible to use chlorides, nitrates, acetates, acetylacetonates, formates, alkoxides and hydroxides—with the inclusion of sparingly soluble hydroxides.

If boron is used as doping element, the doping reagent is usually boric acid.

If indium is used as doping element, the doping reagent is usually selected from indium halides, in particular indium trichloride (InCl₃).

If gallium is used as doping element, the doping reagent is usually selected from gallium halides, in particular GaCl₃.

If the carbon- and silicon-source containing solution or dispersion comprises a doping reagent, the composition usually comprises the doping reagent in amounts of 0.000001 to 15 wt %, in particular 0.000001 to 10 wt %, preferably 0.000005 to 5 wt. %, more preferably 0.00001 to 1 wt. %, based on the solution or dispersion. The properties of the resulting silicon carbide can be decisively changed by the addition of dopant reagents.

If, within the framework of the present invention, an optionally doped stoichiometric silicon carbide is to be provided, it has proven successful if the composition contains the silicon-containing compounds in amounts of 20 to 40 wt %, in particular 25 to 35 wt %, preferably 30 to 40 wt. %, based on the composition.

Furthermore, it may be provided, in accordance with this embodiment, that the solution or dispersion contains the carbon-containing compound in quantities of 20 to 40 wt. %, in particular 25 to 40 wt %, preferably 25 to 35 wt. %, more preferably 25 to 35 wt %, based on the composition.

It may also be provided, in accordance with this embodiment, that the composition contains the solvent or dispersant in quantities of 30 to 80 wt %, in particular 35 to 75 wt. %, preferably 40 to 70 wt. %, more preferably 40 to 65 wt. %, based on the composition.

Furthermore, it is possible that the composition according to this embodiment contains a doping reagent selected in particular from the abovementioned compounds and/or in the quantities mentioned in connection with the doped silicon carbides.

As regards the ratio of silicon to carbon in the carbon- and silicon-source containing solution or dispersion for the preparation of an optionally doped stoichiometric silicon carbide, this may naturally vary in wide ranges. However, it has proven advantageous if the carbon- and silicon-source containing solution or dispersion, in particular the SiC precursor sol, has a weight-related ratio of silicon to carbon in the range from 1:1 to 1:10, in particular 1:2 to 1:7, preferably 1:3 to 1:5, preferably 1:3.5 to 1:4.5. Particularly good results are obtained in the context of this invention if the ratio by weight of silicon to carbon in the carbon- and silicon-source containing solution or dispersion, in particular in the SiC precursor sol, is 1:4. With the aforementioned ratios, silicon carbide fibers as well as nano- and/or microstructured silicon carbide foams, which may still be doped, can be produced in a targeted and reproducible manner.

If a non-stoichiometric silicon carbide, in particular a silicon carbide with an excess of silicon, is to be produced with the composition according to the invention, the composition usually contains the silicon-containing compound in quantities of 20 to 70 wt %, in particular 25 to 65 wt. %, preferably 30 to 60 wt. %, more preferably 40 to 60 wt %, based on the composition.

In accordance with this embodiment, it may also be provided that the composition contains the carbon-containing compound in quantities of 5 to 40 wt. %, in particular 10 to 35 wt %, preferably 10 to 30 wt. %, more preferably 12 to 25 wt %, based on the composition.

In addition, in the event that a non-stoichiometric silicon carbide is to be prepared, it may be provided that the composition contains the solvent or dispersant in amounts of 30 to 80 wt. %, in particular 35 to 75 wt. %, preferably 40 to 70 wt %, more preferably 40 to 65 wt %, based on the composition.

If, in the context of the present invention, a composition for producing a silicon carbide alloy is to be provided, it has proven advantageous if the composition contains the silicon-containing compound in amounts of 1 to 80 wt %, in particular 2 to 70 wt. %, preferably 5 to 60 wt. %, more preferably 10 to 30 wt. %, based on the composition.

Furthermore, it may be provided according to this embodiment that the composition contains the carbon-containing compound in quantities of 5 to 50 wt. %, in particular 10 to 40 wt %, preferably 15 to 40 wt. %, more preferably 20 to 35 wt %, based on the composition.

Likewise, according to this embodiment, it may be provided that the composition contains the solvent or dispersant in quantities of 10 to 60 wt %, in particular 15 to 50 wt %, preferably 15 to 40 wt %, more preferably 20 to 40 wt. %, based on the composition.

Furthermore, according to this embodiment, it may be provided that the composition contains the alloying reagent in quantities of 5 to 60 wt %, in particular 10 to 45 wt %, preferably 15 to 45 wt. %, more preferably 20 to 40 wt. %, based on the composition.

In the present invention, it is particularly preferred when the alloying reagent is selected from the corresponding chlorides, nitrates, acetates, acetylacetonates and formates of the alloying elements, in particular alloying metals. The alloying element or metal is usually selected from the group consisting of Al, Ti, V, Cr, Mn, Co, Ni, Zn, Zr and mixtures thereof.

In the context of the present invention it is usually provided that the precursors are introduced in fine distribution into the reactor, in particular injected. A fine distribution of the precursors results in rapid decomposition of gaseous precursors or a rapid and complete transfer of liquid precursors into the gas phase, so that the precursors are completely and rapidly decomposed into reactive species.

As far as the substrate is concerned, the substrate can be selected from a variety of suitable materials and objects. Usually, however, the substrate is selected from metal substrates, in particular metal foils or metal sheets, graphite substrates, in particular graphite panels and/or graphite fibers, carbon nanotubes, carbon fiber reinforced plastic panels, ceramic substrates, silicon carbide substrates and mixtures thereof. For the production of silicon carbide-containing foams, substrates with a very flat surface, such as metals or metal foils, ceramic panels or silicon carbide substrates, are preferred, whereas separate, i.e. isolated, silicon carbide-containing fibers are preferably produced on structured substrates, in particular graphite panels and/or graphite fibers, carbon nanotubes, carbon fiber-reinforced plastic panels or structured silicon carbide or ceramic panels.

The metals of the metal substrates are in particular precious metals and alloys thereof, in particular copper, silver, gold, platinum and alloys thereof, with copper being preferred.

In the context of the present invention it is usually provided that the method is carried out in a protective gas atmosphere, in particular in an inert gas atmosphere.

In the context of the present invention, a protective gas is defined as a gas which, in particular, prevents the oxidation of carbon and silicon by atmospheric oxygen, in particular the formation of silicon dioxide and carbon monoxide or carbon dioxide. A protective gas may itself participate in the formation reaction of the silicon carbide and be incorporated into the silicon carbide structure as a doping element. In the context of the present invention, an inert gas is a gas which is absolutely inert under the reaction conditions and which does not react with the precursors or with their decomposition and reaction products.

In the context of this invention, nitrogen, for example, is a protective gas, but not an inert gas, since nitrogen can be incorporated into the silicon carbide structure in the form of dopants at the prevailing high temperatures. Argon, on the other hand, is not only a protective gas but also an inert gas since it is not involved in the reactions.

If, in the context of the present invention, the method is carried out in a protective gas atmosphere, it has proven successful if the protective gas is selected from nitrogen and noble gases, in particular argon. Particularly good results are obtained in this context if the protective gas is selected from nitrogen and argon, in particular argon.

As far as the pressure at which the method according to the invention is carried out is concerned, this can also vary widely. Usually, however, the method is carried out at normal pressure or negative pressure. In the context of this invention, normal pressure is understood to mean the ambient pressure, which fluctuates slightly around the range of 1.013 bar.

In accordance with a preferred embodiment of the present invention, it is provided that the temperatures in the first temperature zone of the reactor are set to 1,500 to 2,100° C., in particular 1,600 to 2,000° C., preferably 1,700 to 1,900° C., for producing the silicon carbide-containing fibers, in particular the separate, i.e. separated, silicon carbide-containing fibers.

Furthermore, according to this embodiment of the present invention, it may also be provided that for producing the silicon carbide-containing fibers, the temperature in the second zone of the reactor is set to 50 to 300° C., in particular 80 to 250° C., preferably 100 to 200° C., lower than in the first zone of the reactor.

In the context of the present invention, it may therefore be provided that during the production of the silicon carbide-containing fibers, the temperatures in the second zone of the reactor are set in the range of 1,200 to 2,000° C., in particular 1,500 to 1,900° C., preferably 1,600 to 1,800° C.

In accordance with another preferred embodiment of the present invention, it may be provided that for producing the silicon carbide-containing nano- and/or micro-structured foams, the temperatures in the first zone of the reactor are set to 1,100 to 1,800° C., in particular 1,200 to 1,600° C., preferably 1,300 to 1,500° C.

Furthermore, in accordance with this embodiment of the present invention, the temperature in the second zone of the reactor may be set to 30 to 200° C., in particular 40 to 150° C., preferably 50 to 100° C., lower than in the first zone of the reactor, in order to produce the silicon carbide-containing nano- and/or microstructured foams.

Likewise, it may be provided within the scope of the present invention that, for the production of the nano- and/or micro-structured silicon carbide-containing foams, the temperatures in the second zone of the reactor are set to values in the range of 1,000 to 1,500° C., in particular 1,050 to 1,400° C., preferably 1,100 to 1,250° C.

In the context of the present invention, it emerged that either silicon carbide-containing foams with crosslinked silicon carbide-containing fibers or separate, i.e. separated, silicon carbide-containing fibers can be obtained by selecting different temperature regimes.

The following figures show according to

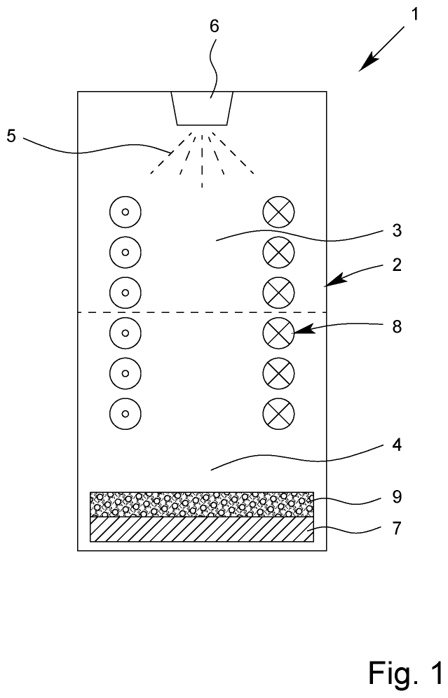

FIG. 1: an inventive apparatus for producing silicon carbide-containing fibers or silicon carbide-containing nano- and/or micro-structured foams,

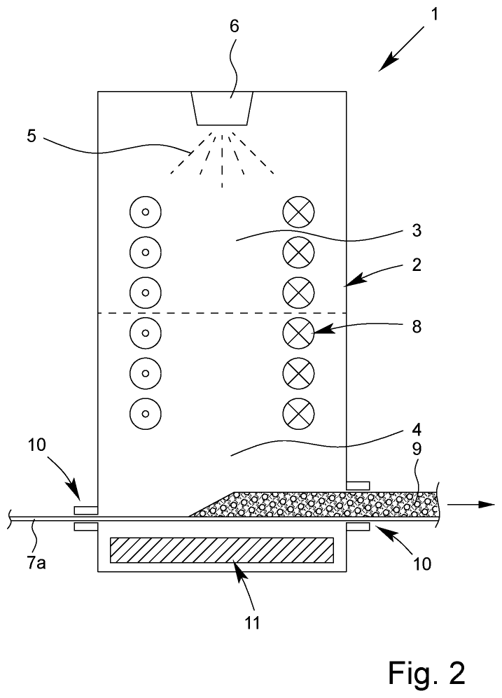

FIG. 2: an apparatus according to the invention for applying nano- and/or microstructured silicon carbide foams to surface structures,

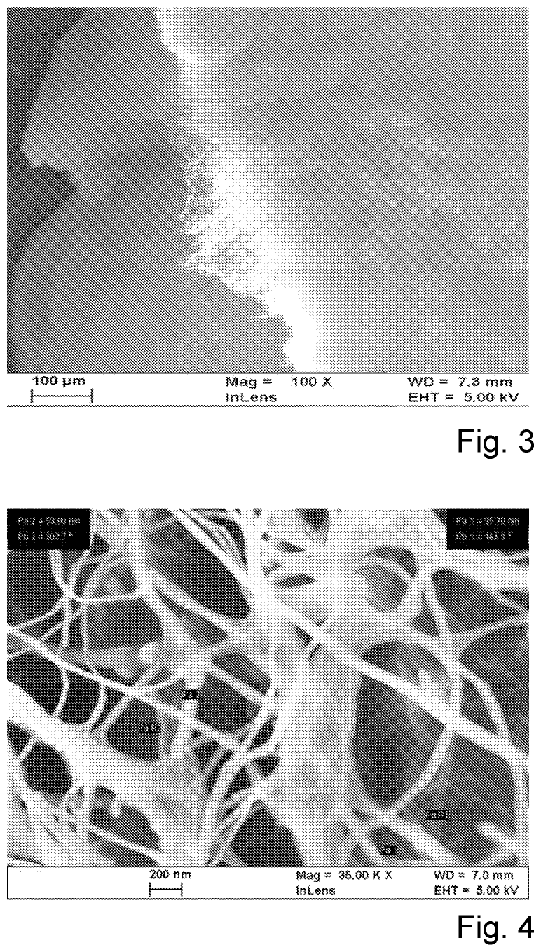

FIG. 3: an image of a nano- and/or microstructured silicon carbide foam in 100× magnification, and

FIG. 4: an image of a nano- and/or microstructured silicon carbide foam at 35,000× magnification.

A further subject-matter of the present invention—according to a second aspect of the present invention—are silicon carbide-containing fibers which are obtainable by the method described above.

The silicon carbide-containing fibers according to the invention are excellently suited as reinforcements or armoring, for example in plastics or building materials, such as plasters, in order to improve their respective mechanical properties. The silicon carbide-containing fibers can also be used for composite materials, for example in lightweight construction applications or translucent laminated glass.

Silicon carbide fibers can be used as anode materials for lithium ion accumulators for producing silicon carbide fibers or doped silicon carbide. In particular, the fibers can be processed into electrodes, in particular anode materials, using binders and, if necessary, conductivity improvers such as conductive soot

For further details on this aspect of the invention, please refer to the above comments on the process in accordance with the invention, which apply analogously to the silicon carbide-containing fibers according to the invention.

Another subject-matter of the present invention—according to a third aspect of the present invention—is the use of the previously described silicon carbide-containing fibers for producing composite materials, in particular for lightweight construction applications or laminated glass, and/or as reinforcing filler.

As already mentioned above, the silicon carbide-containing fibers in accordance with the invention, in particular individual fibers, i.e. separate silicon carbide-containing fibers, can be used as reinforcements in composite materials. This applies in particular to fibers based on non-stoichiometric silicon carbides and silicon carbide alloys.

For further details on this aspect of the invention, reference is made to the above descriptions of the other invention aspects, which apply correspondingly to the inventive use.

Another subject-matter of the present invention—according to a fourth aspect of the present invention—is the use of the previously described silicon carbide-containing fibers, in particular silicon carbide fibers, for producing anodes and/or as anode material.

The silicon carbide fibers are used in particular as anode materials for lithium ion accumulators.

For further details on this aspect of the invention, reference is made to the above descriptions of the other invention aspects, which apply analogously to the inventive use.

Further subject-matter of the present invention—according to a fifth aspect of the present invention—are silicon carbide-containing nano- and/or microstructured foams, obtainable by the method described above.

The specific surface area of the silicon carbide-containing foams obtainable by the inventive method is usually in the range from 15,000 to 70,000 m²/m³, in particular 20,000 to 60,000 m²/m³, preferably 25,000 to 50,000 m²/m³.

The specific density of the silicon carbide-containing foams obtainable by the method according to the invention lies in the range from 0.01 to 0.8 g/cm³, in particular 0.05 to 0.6 g/cm³, preferably 0.1 to 0.5 g/cm³.

The silicon carbide-containing foams obtainable by the method according to the invention are extremely resistant to thermal, chemical and mechanical stress and possess excellent electrical properties. They not only withstand temperatures of up to 1,600° C. and high pressure loads without destruction, but also retain their good electrical properties after a large number of loading and unloading cycles with lithium ions. They are suitable for all applications in which permanently elastic materials are used.

The silicon carbide-containing nano- or microstructured foams according to the invention can also be used in an excellent way as sealing or insulating materials, in particular for the absorption of vibration and/or sound, as well as material for suspensions, springs or dampers. Materials based on non-stoichiometric silicon carbide or silicon carbide alloys are particularly suitable for the above applications, while doped silicon carbide may be used for electrical or electronic applications.

For further details on this aspect of the invention, reference is made to the above descriptions of the further aspects of the invention, which apply correspondingly to the nano- and/or micro-structured silicon carbide foams according to the invention.

Another subject-matter of the present invention—according to a sixth aspect of the present invention—is the use of nano- and/or microstructured silicon carbide-containing foams in seals, suspensions, spring stanchions, dampings, insulations, in particular for absorbing vibration and/or sound, membranes and filters.

For further details on this aspect of the invention, reference is made to the above descriptions of the other invention aspects, which apply correspondingly to the inventive use.

Again, another subject-matter of the present invention—according to a seventh aspect of the present invention—is the use of nano- and/or microstructured silicon carbide-containing foams, in particular nano- and/or microstructured silicon carbide foams, for producing anodes and/or as anode material as described above.

For further details on this aspect of the invention, reference is made to the above descriptions of the further invention aspects, which apply correspondingly to the use in accordance with the invention.

Further subject-matter of the present invention—according to an eighth aspect of the present invention—is an apparatus for producing silicon carbide-containing fibers or silicon carbide-containing nano- and/or micro-structured foams, wherein the apparatus comprises
(a) at least one reactor comprising
   (i) a first temperature zone; and
   (ii) a second temperature zone,
      wherein the temperatures in the two temperature zones, in particular independently of one another, are controllable, in particular by a control unit,
(b) at least one introduction device, in particular injection device, for introducing, in particular injecting, gaseous and/or liquid precursors, containing at least one carbon source and at least one silicon source and, optionally, doping reagents, into the first temperature zone of the reactor; and
(c) at least one substrate in the second temperature zone of the reactor for depositing the silicon carbide-containing fibers and/or the silicon carbide-containing nano- or microstructured foams.

The first temperature zone of the reactor is also referred to as the reaction zone in the context of the present invention, since here the reactive intermediate stages or species are formed from the precursors, which are then deposited on the substrate as a silicon carbide-containing compound, in particular as silicon carbide. The second temperature zone of the reactor is also called the SiC formation zone, since the first condensations of the reactive species formed during the decomposition of the precursors takes place in this zone.

In general, it is intended that the temperature in the first temperature zone is controllable in the range from 1,100 to 2,100° C., in particular 1,200 to 2,000° C., preferably 1,200 to 1,900° C.

Furthermore, it may be provided within the framework of the present invention that a temperature gradient between the first and the second temperature zone is settable, in particular wherein the temperature in the second temperature zone can be set lower than in the first temperature zone. With regard to further information on temperature control in the first and second temperature zones, in particular for the specific temperature control regimes for producing the silicon carbide-containing fibers and the silicon carbide-containing nano- or micro-structured foams, reference can be made to the above remarks on the invention-based process.

According to a preferred embodiment of the present invention, the temperature in the reactor can be controlled in such a way that the temperature gradient in the reactor continues all the way to the substrate, so that the substrate has the surface with the lowest temperature in the reactor and silicon carbide-containing fibers and foams, in particular silicon carbide fibers or silicon carbide foams, are exclusively deposited on the substrate. As mentioned above, the substrate is usually located in the second temperature zone of the reactor. In order to achieve that the substrate has an even lower temperature than the second temperature zone, heating devices in the vicinity of the substrate can be dispensed with or the substrate can be moved through the reactor, in particular continuously. This applies in particular if the substrate can be moved out of the reactor or if the residence time of the substrate in the reactor is only very short. It is also possible that the substrate is specially tempered, as explained below. Temperature control of the substrate is particularly advantageous if the substrate is made of metal, in particular a metal foil. If the substrate is made of metal, in particular a metal foil, it has proven useful if the substrate temperature is not higher than 1,000° C., in particular not higher than 950° C., and preferably not higher than 900° C. The temperature of the substrate can be controlled by means of a temperature control system. Particularly good results are obtained in this context if the substrate temperature is adjustable in the range of 700 to 1,000° C., in particular 800 to 950° C., preferably 850 to 900° C.

In general, the reactor the reactor comprises at least one heating device, in particular in the region of the first temperature zone. According to a preferred embodiment of the present invention, the reactor has at least one heating device in both the first and the second temperature zone.

As far as the type of heating device is concerned, this can be selected from a large number of heating devices. In the context of the present invention, however, it has proven advantageous if the heating device is selected from microwave radiators, infrared radiators, radiant heaters, electric resistance heaters and their combinations, in particular microwave radiators, electric resistance heaters and combinations thereof.

The heating devices mentioned above all allow a very continuous and above all a very rapid heating of the liquid and/or gaseous precursors and their rapid decomposition.

In accordance with a preferred embodiment of the present invention, the reactor may comprise at least one transport device for transporting the substrate in the reactor, in particular through the reactor, and/or for introducing the substrate into the reactor and for removing the substrate from the reactor. With a transport device for transporting the substrate through the reactor, a low temperature of the substrate can be achieved very easily since the residence time of the substrate in the reactor is shortened. Thus, the substrate has already left the reactor before it has completely heated to the temperatures prevailing in the second temperature zone of the reactor. In addition, this embodiment enables continuous process control, in particular continuous loading of a substrate with silicon carbide-containing fibers or silicon carbide-containing nano- and/or microstructured foams, in particular silicon carbide fibers or nano- and/or microstructured silicon carbide foams.

In accordance with a preferred embodiment of the present invention, it may be provided that the reactor has at least one, preferably several, preferably at least two sluice devices, for introduction of the substrate into the reactor and/or for removal of the substrate from the reactor, in particular for introduction and/or removal of the substrate. Such a sluice system also enables continuous process control, in which substrate is continuously introduced into the reactor and coated substrate is removed from the reactor.

In addition, the present invention may provide for the reactor and/or the transport device comprises a tempering device for tempering the substrate. The temperature of the substrate can be precisely adjusted by means of the tempering device. In particular, when coating thin metal foils, for example, it can be prevented that these are damaged or melted at the temperatures of often more than 1,000° C. prevailing in the second temperature zone of the reactor.

For further details on this aspect of the invention, reference is made to the above descriptions of the other invention aspects, which apply correspondingly to the inventive device.

A further subject-matter of the present invention—according to a ninth aspect of the present invention—is a method for applying a nano- and/or microstructured silicon carbide foam to a sheet material, in particular a method for producing an electrode, wherein
(a) solid, liquid and/or gaseous precursors containing at least one carbon source and at least one silicon source are introduced into a first zone, in particular a first temperature zone, of a reactor and heated to temperatures in the range from 1,100 to 1,800° C. so that the precursors are decomposed, and
(b) in a second zone, in particular in a second temperature zone, of the reactor a nano- or microstructured silicon carbide foam is deposited on a sheet material.

In accordance with this embodiment of the present invention, it is usually provided that the temperatures in the first temperature zone of the reactor are set to 1,100 to 1,800° C., in particular 1,200 to 1,600° C., preferably 1,300 to 1,500° C.

In addition, it is usually provided in the context of the present invention that the temperature in the second zone of the reactor is set to 30 to 200° C., in particular 40 to 150° C., preferably 50 to 100° C., lower than in the first zone of the reactor.

The temperature regime therefore preferably corresponds to that previously described in connection with the inventive method for producing silicon carbide-containing nano- and microstructured foams.

As far as the inventive method for applying a surface structure is concerned, a surface structure, in particular a metallic surface structure, in the context of the present invention is to be understood as an almost two-dimensional object, in particular made of metal, in particular a metal foil or metal sheet

In the context of this invention it is usually intended that the sheet material contains or consists of ceramics, in particular silicon carbide, graphite or at least one metal.

For, as applicant surprisingly found out, nano- and/or microstructured silicon carbide foams can be deposited directly on sheet materials so that binder-free electrode materials, in particular anodes, are accessible for lithium ion accumulators in a simple manufacturing process.

The direct application of silicon carbide foams, in particular foams made of doped silicon carbide, to metals, in particular metal foils or metal sheets, facilitates the production of highly porous and highly conductive anodes for lithium ion batteries, which do not require the use of binders required in state-of-the-art anode systems for fixing graphite, tin or silicon particles.

When using flat ceramic or graphite structures, it is possible to produce bipolar electrodes which can be arranged directly in stacks and make an external electrical connection of individual cells superfluous. The use of bipolar electrodes and the stacks available with them have significant advantages over conventional electrical cells in terms of volume, manufacturing technology and cost. For the derivation of electrical currents over a few micrometers in bipolar electrodes, it is not necessary to use highly conductive metals, but a derivation via ceramic, such as silicon carbide, or graphite is sufficient, so that nano- and/or microstructured silicon carbide foams can be applied as anode materials directly to a collector made of ceramic materials or graphite. A cathodic layer is then applied to obtain a bipolar electrode.

The electrodes produced with the method according to the invention are characterized by an increased thermal and mechanical resilience compared to state-of-the-art electrodes, since the monocrystalline or nanocrystalline silicon carbide foams can be thermally loaded up to approx. 1,600° C. In addition, the foam is dimensionally stable and very pressure-resistant, yet flexible enough not to break under high local pressure, but to deform elastically and return to its original state after the end of the pressure load. On the other hand, the high porosity of the electrode materials, in particular anodes, which are accessible by the inventive method, allows a complete penetration of the foam structure with the electrolyte of a lithium ion accumulator, so that the high storage potential of the silicon carbide fibers for lithium ions can actually be fully used. Due to the high porosity and the resulting large surface area of the resulting electrode materials, a fast supply and release of lithium ions is possible.

In the context of the present invention, it is usually intended that the sheet material is a metallic sheet material, in particular a metal sheet or foil.

As far as the material of the metallic sheet material is concerned, this can be selected from all suitable metals and their alloys, with particular focus on high electrical conductivity. In the context of the present invention, it is usually intended that the metal of the metallic surface is a precious metal or a precious metal alloy. In this context, particularly good results are obtained if the metal of the metallic sheet material is selected from copper, silver, gold, platinum and alloys thereof. In particular, the use of copper is particularly preferred, since copper does not only have excellent electrical conductivity, but is also comparatively inexpensive and available in large quantities compared to other precious metals.

As far as the thickness of the sheet material is concerned, the sheet material generally has a thickness of 1 to 1,000 μm, in particular 5 to 100 μm, preferably 10 to 20 μm. The thickness of the sheet material, in particular if it is in the form of a foil or a sheet, is therefore negligible compared to the width, which can be up to 50 cm or more, and the length, which can be up to several meters or even kilometers.

According to a preferred embodiment of the present invention, the metallic sheet material is in the form of a strip or in the form of panels, in particular a graphite or metal strip. The process can be operated continuously by using strips, in particular graphite or metal strips, preferably metal sheets or metal foils.

When using ceramic materials for the sheet material, the use of panels is particularly suitable, which are preferably moved through the reactor in order to achieve as uniform a coating of the panels as possible.

In accordance with a preferred embodiment of the present invention, the sheet material is coated in sections and/or continuously with the nano- and/or microstructured silicon carbide foam. It is particularly preferred in this context if the sheet material is continuously coated with the nano- and/or microstructured silicon carbide foam. By continuously coating the sheet material with the nano- and/or microstructured silicon carbide foam, a large number of electrodes, in particular anodes, can be produced for lithium ion accumulators, making the process according to the invention particularly economical.

According to a preferred embodiment of the present invention, it is intended that the sheet material is moved through the reactor, in particular is moved continuously through the reactor. By a movement, in particular a continuous movement of the sheet material through the reactor, in particular through the second temperature zone of the reactor, it is possible to also produce thin foils of metals with a low melting point, such as copper foils, with nano- and/or microstructured silicon carbide foams without damaging or destroying the sheet material, since the residence time of the sheet material in the reactor is reduced. In addition, the movement of the sheet material through the reactor also provides a simple option for preparing the coating thickness.

If the metallic sheet material is moved through the reactor, in particular continuously through the reactor, it is usually necessary to transfer the sheet material into the reactor and out again, in particular also in continuous operation. Appropriate suitable sluices are familiar to the expert and known to the state of the art.

If the sheet material is moved through the reactor, the metallic sheet material is usually moved through the reactor at a speed of 0.05 to 2 m/s, in particular 0.08 to 1 m/s, preferably 0.1 to 0.5 m/s. At the feed rates mentioned above, the method according to the invention can be carried out on an industrial scale as well, so that a large number of electrodes, in particular anodes, can be quickly provided for lithium ion accumulators within a short time.

According to another preferred embodiment of the present invention, it is provided that the sheet material, in particular the metallic sheet material, is tempered in the reactor. In this context, it may be provided that the sheet material in the reactor is tempered to temperatures in the range of 700 to 1,000° C., in particular 800 to 950° C., preferably 850 to 900° C. Due to a special temperature control of the sheet material, for example the underside of the sheet material, even metallic sheet materials with a low melting point and a very low layer thickness can be exposed to nano- and/or microstructured silicon carbide foams. In addition, the deposition rate can also be influenced by the temperature of the substrate.

In the context of the present invention, it may also be provided that the sheet material is treated from both sides with a nano- and/or microstructured silicon carbide foam, in particular by first treating one side of the sheet material and then treating the other side of the sheet material in a second reactor and/or by passing through the reactor again.

In addition, it is possible and advantageously provided that the sheet material exposed to the nano- and/or microstructured silicon carbide foam is assembled after removal from the reactor. The assembly directly produces electrodes for lithium ion accumulators, which are immediately ready for use. In particular, if the surface structure is continuously exposed to nano- and/or microstructured silicon carbide foams, it is essential that the electrodes are assembled before they are installed in accumulators.

With regard to the general process parameters and in particular also the liquid and/or gaseous precursors, reference can be made to the above remarks on the inventive process for the production of silicon carbide-containing fibres or silicon carbide-containing nano- and/or microstructured foams. With regard to this aspect of the present invention, particular reference is made to the features and embodiments which relate to the production of silicon carbide-containing nano- and/or microstructured foams.

With regard to the manufacture of suitable solid precursors, reference is made in particular to the international application WO 2016/078955 A1, the contents of which are hereby expressly made subject of this invention. The further method parameters for applying solid precursors to sheet materials correspond to those for using liquid and/or gaseous precursors.

If solid precursors are used in the context of the present invention, a precursor granulate is usually used, which is preferably available from the solution or dispersion containing carbon and silicon sources, in particular precursor sol, described in connection with the inventive method for producing silicon carbide fibers and nano- or microstructured silicon carbide foams.

In this context, it is particularly preferred if the precursor granulate is obtainable by a sol-gel process. In sol-gel processes, solutions or fine-particle solid-in-liquid dispersions are usually produced, which are converted into a gel containing larger solid particles by subsequent aging and the condensation processes that occur as a result.

For the production of precursor granulates, the reaction rate of the individual reactions taking place in solution or dispersion has to be coordinated, since hydrolysis, condensation and, in particular, gelation need to take place undisturbed prior to granulate formation. The reaction products formed should not be sensitive to oxidation and should also not be volatile.

After drying of the gel, a particularly homogeneous composition, in particular a suitable precursor granulate, can be obtained with which the desired silicon carbide-containing compounds can be prepared under method conditions if a suitable stoichiometry is selected.

As far as the production of precursor granulates from a solution or dispersion, in particular a precursor sol, is concerned, it has proven successful if the reaction product of the gelation is dried at temperatures in the range of 50 to 400° C., in particular 100 to 300° C., preferably 120 to 250° C., more preferably 150 to 200° C.

As far as the duration of drying is concerned, this can vary over a wide range. However, it has proven successful if the reaction product of the gelation is dried for a period of 1 to 10 hours, in particular 2 to 5 hours, preferably 2 to 3 hours.

It is also possible that the precursor granulate is crushed, in particular after the drying process. In this context, it is particularly preferred if the reaction product is mechanically comminuted, in particular by grinding. Grinding processes can be used to specifically adjust the particle sizes required or advantageous for rapid gasification of the particles. However, it is often sufficient to mechanically stress the reaction product of the gelation during the drying process, for example by stirring, in order to adjust the desired particle sizes.

It can be envisaged that the precursor granulate is converted into a reduced precursor granulate by thermal treatment under reductive conditions. The reductive thermal treatment usually takes place in an inert gas atmosphere, whereby in particular the carbon source, preferably a sugar-based carbon source, reacts with oxides or other compounds of silicon as well as any other compounds of other elements, in particular the doping elements, whereby the elements are reduced and volatile oxidized carbon and hydrogen compounds, in particular water and CO₂, are formed, which are removed via the gas phase.

The use of a reduced precursor granulate, which has undergone a reductive treatment, has the advantage that a large number of possible and disturbing by-products have already been removed. The resulting reduced precursor granulate is even more compact and contains higher proportions of the elements which form the possibly doped silicon carbide.

If a reductive thermal treatment of the precursor granulate is carried out after drying of the precursor granulate, it has proven advantageous to heat the precursor granulate to temperatures in the range from 700 to 1,300° C., in particular 800 to 1,200° C., preferably 900 to 1,100° C.

In this context, particularly good results are obtained if the precursor granulate is heated for a period of 1 to 10 hours, in particular 2 to 8 hours, preferably 2 to 5 hours. In the specified temperature ranges and reaction times, carbonization of the carbon-containing precursor material can take place, which can significantly facilitate subsequent reduction, in particular of metal compounds.

In general, the reducing treatment of the precursor granulates is carried out in an inert gas atmosphere, in particular in an argon and/or nitrogen atmosphere. This prevents oxidation of the carbon-containing compound in particular.

If a reducing thermal treatment of the precursor granulates as described above is planned in order to obtain a reduced precursor granulate, the precursor compounds should not evaporate at the applied temperatures of up to 1,300° C., preferably up to 1,100° C., but may selectively decompose under the reductive thermal conditions into compounds which can be converted into the desired silicon carbide-containing compounds during the production of the silicon carbide fibers and foams.

For further details on this aspect of the invention, reference is made to the above descriptions of the other invention aspects, which apply accordingly with regard to the method in accordance with the invention.

Further subject-matter of the present invention—according to a tenth aspect of the present invention is an electrode, obtainable by the method described above.

For further details on this aspect of the invention, reference is made to the above explanations on the other aspects of the invention, which apply correspondingly for the electrode according to the invention.

Again, another subject-matter of the present invention—according to an eleventh aspect of the present invention—is an electrode comprising a sheet material and a nano- and/or microstructured silicon carbide foam.

The present invention, for the first time, allows the provision of electrodes, in particular anodes, which only comprise a sheet material, in particular a metallic sheet material, and a nano- and/or micro-structured silicon carbide foam. In this context, it is intended in particular that the metallic sheet material is exposed to the nano- and/or micro-structured silicon carbide foam.

In accordance with a preferred embodiment of the present invention, it is intended that the electrode is in particular at least essentially free of binders.

By dispensing with the use of binders, the efficiency of the electrode according to the invention can be significantly increased in comparison with state-of-the-art electrodes, since the electrode material, with the exception of the discharge plate or collector, consists of ceramic material or graphite consisting solely of silicon carbide foams or fibers which can absorb and release lithium ions. Also, by suitable doping, the conductivity of the silicon carbide can be adjusted in such a way that no conductivity improvers are required.

In the context of the present invention, it is preferably provided that the electrode consists of an in particular assembled sheet material, in particular metallic sheet material, and a nano- and/or microstructured silicon carbide foam.

For further details on this aspect of the invention, reference is made to the above explanations on the other aspects of the invention, which apply accordingly to the electrode in accordance with the invention.

Again, a further subject-matter of the present invention—according to a twelfth aspect of the present invention—is a lithium ion accumulator, comprising an above-mentioned electrode, in particular an anode.

The lithium ion accumulator according to the invention may, for example, be designed as a stack of bipolar electrodes, as previously described.

For further details on this aspect of the invention, reference is made to the above explanations on the other aspects of the invention, which apply accordingly to the lithium ion accumulator corresponding to the invention.

Finally, further subject-matter of the present invention—according to a thirteenth aspect of the present invention—is an apparatus for applying a nano- and/or micro-structured silicon carbide foam to a sheet material, in particular an apparatus for producing an electrode,

wherein the apparatus comprises
(a) at least one reactor comprising
   a first temperature zone; and
   (ii) a second temperature zone,
      wherein the temperatures in the two temperature zones, in particular independently of one another, are controllable, in particular by a control unit,
(b) at least one introduction device for introducing solid, liquid and/or gaseous precursors, containing at least one carbon source and at least one silicon source and, optionally, doping reagents, into the first temperature zone of the reactor and
(c) at least one transport device for moving a sheet material through the reactor (2), in particular through the second temperature zone of the reactor, and/or a tempering device for tempering the sheet material.

By moving the sheet material, in particular a metallic sheet material, through the second temperature zone of the reactor, in particular by continuously moving the sheet material through the second temperature zone of the reactor, and/or by tempering the sheet material, it is achieved that thin metallic sheet materials with a low melting point can also be coated with nano- and/or microstructured silicon carbide foams. In this way, electrode materials, in particular anode materials for lithium ion accumulators, are directly accessible without the use of binders.

The layer thickness of the silicon carbide foam on the sheet material and the deposition rate of the silicon carbide foam can also be adjusted.

In addition, the apparatus for applying nano- or micro-structured silicon carbide foams to sheet materials corresponds to the apparatus for producing silicon carbide fibers or nano- and/or microstructured silicon carbide foams, the substrate mentioned there corresponding to the sheet material.

For further details on this aspect of the invention, reference is made to the above explanations on the other aspects of the invention, which apply correspondingly to the apparatus according to the invention.

The subject-matter of the present invention is described in the following on the basis of the figure representation as well as the working examples by means of preferred forms of embodiment, without restriction, however, of the subject-matter of the present invention to these preferred embodiments.

The figure shows, according to FIG. 1, an apparatus 1 according to the invention for producing silicon carbide-containing fibers or silicon carbide-containing nano- or microstructured foams.

Apparatus 1 comprises a reactor 2 with a first temperature zone 3 and a second temperature zone 4. The transition between the first and the second temperature zone is shown by the dotted line in the middle of reactor 2. In fact, there is no sharp separation between the two temperature ranges, but rather a preferred temperature gradient is set in the reactor.

To carry out the method according to the invention, liquid or gaseous precursors 5, in particular also precursor sols, are introduced into the reactor 2 by means of an introduction device 6, in particular an injection device, in particular into the first temperature zone 3.

The temperature in reactor 2 is preferably set in such a way that a temperature gradient prevails in the second temperature zone 4 from the introduction device 6 for the introduction of liquid and/or gaseous precursors 5 in the first temperature zone 3 to a substrate 7 for the deposition of silicon carbide-containing fibers or foams, in particular silicon carbide fibers or fiber foams 9, in particular wherein the temperature in the second temperature zone 4 is preferably 30 to 300° C. lower than in the first temperature zone 3.

The temperature in the first temperature zone 3 is usually 1,100 to 2,100° C. The temperature in the second temperature zone 4 is preferably 30 to 300° C. lower than in the first temperature zone 3. To set the temperature, the apparatus 1 comprises heating devices 8 in the reactor 2, at least in the first temperature zone 3, but preferably in the first temperature zone 3 and the second temperature zone 4. The heating device 8 is preferably a microwave radiator or an electrical resistance heater.

In the first temperature zone 3, precursors 5 are decomposed and converted into reactive species. The reactive species then diffuse into the slightly cooler second temperature zone 4, where first agglomerates form, which condense on the substrate 7 and form isolated silicon carbide fibers or a layer of silicon carbide foam 9. The figure shows only the production of silicon carbide foams 9, whereby the production of separate fibers is completely analogous, but at a different temperature regime. The production of fibers and foams from other silicon carbide-containing materials, in particular silicon carbide alloys, also proceeds accordingly. For reasons of clarity, only the production of silicon carbide foams is described in the figure description.

According to a preferred embodiment of the present invention, the temperature gradient, in particular the temperature gradient in the reactor, is adjusted in such a way that the substrate 7 has the lowest temperature in the entire reactor 2, so that the silicon carbide fibers or the silicon carbide foams 9 are deposited exclusively on the substrate 7.

For the production of nano- or microstructured silicon carbide foams 9, the temperature of a first temperature zone 3 of reactor 2 is usually 1,100 to 1,800° C., in particular 1,200 to 1,600° C., preferably 1,300 to 1,500° C., and in contrast is approximately 50 to 100° C. lower in the second temperature zone 4 of reactor 2.

For the production of separate silicon carbide fibers, the temperature in the first temperature zone 3 of reactor 2 is approximately 1,600 to 2,000° C. and is lowered by approximately 100 to 200° C. in the second temperature zone 4.

The method for producing separate silicon carbide fibers as well as for producing nano- or microstructured silicon carbide foams is preferably carried out in an inert gas atmosphere, in particular an argon atmosphere.

After the synthesis of the silicon carbide fibers or foams 9 has been completed, either the fibers or foams 9 are removed from the surface of the substrate 7, or the substrate 7, which has been charged with silicon carbide fibers or foams 9, is removed from reactor 2.

Furthermore, FIG. 2 shows a special embodiment of the method according to the invention as well as of the apparatus 1 according to the invention for applying nano- or micro-structured silicon carbide foams to sheet materials.

This special embodiment of the method or apparatus according to the invention is illustrated in the following by means of a metallic sheet structure, whereby sheet structures made of ceramic or graphite can also be used.

Apparatus 1 has a reactor 2 with a first temperature zone 3 and a second temperature zone 4.

A temperature gradient is preferably present in reactor 2, whereby in particular the temperature in the second temperature zone 4 is lower than in the first temperature zone 3. The temperature in the first temperature zone 3 is preferably 1,200 to 1,600° C. and the temperature in the second temperature zone 4, on the other hand, is preferably lower by 50 to 100° C.

In addition, apparatus 1 comprises at least one introduction device 6 for introducing solid, liquid and/or gaseous precursors 5 into reactor 2.

Adjustment of the temperature zones in reactor 2, in particular heating of precursors 5, is carried out by means of heating devices 8, which are located at least in the first temperature zone 3 of reactor 2, but preferably both in the first temperature zone 3 and in the second temperature zone 4 of reactor 2.

Apparatus 1 also comprises sluice devices 10 for the inward and outward transfer of a metallic sheet material 7a, in particular a metal foil or metal sheet. In addition, the device has at least one tempering device 11 for tempering the metallic sheet material 7a.

Reactor 2 is preferably filled with an inert gas, in particular argon, and the method is preferably carried out in an inert gas atmosphere.

In order to carry out the method in accordance with the invention corresponding to this embodiment, solid, liquid and/or gaseous precursors 5 are introduced into reactor 2 in fine distribution by means of the introduction device 6, in particular into the first temperature zone of reactor 2, where the precursors 5 are heated to temperatures in the range of 1,200 to 1,600° C. If solid precursors 5 are used, the introduction device 6 is preferably located in the bottom of reactor 2 and the metallic sheet material 7a is guided through the upper part of reactor 2, which is then located in the second temperature zone 4. In this way, it is prevented that non-gasified solid matter falls onto or is incorporated into the silicon carbide structure produced. Alternatively, the solid precursors 5 can be converted into a gaseous state in an upstream chamber, so that gaseous precursors 5 can then be introduced into reactor 2 as already described.

By heating the precursors 5, these are decomposed and gasified as completely as possible, whereby reactive species are released which diffuse into the second reaction zone 4 and form the first agglomerates in the gas phase there. The reactive species and agglomerates are deposited in the form of a silicon carbide foam 9 on the metallic sheet material 7a.

Preferably, the temperature in the interior of reactor 2 is controlled in such a way that the temperature of the metallic sheet material 7a in the second reaction zone 4 of reactor 2 is below the temperature of the second temperature zone 4, so that the silicon carbide foam 9 is deposited exclusively on the metallic sheet material 7.

Preferably, the metallic sheet material 7a is moved through reactor 2, in particular the second temperature zone 4 of reactor 2, so that a continuous coating or application of the nano- or microstructured silicon carbide foam 9 to the metallic sheet material 7a is possible.

A movement, in particular a continuous movement, of the metallic sheet material 7a through the reactor 2, in particular the second temperature zone 4 of the reactor 2, it can also be ensured that the temperature of the metallic sheet material 7a is lower than the temperature of the reactor 2 in the second temperature zone 4, so that the nano- or microstructured silicon carbide foam 9 is exclusively deposited on the metallic sheet material 7a. This enables, in particular, the application or coating of nano- or micro-structured silicon carbide foams 9 to metallic sheet materials 7a with a relatively small layer thickness.

In order to ensure very uniform temperature control of the metallic sheet material 7a, it may be provided that the apparatus 1 has a tempering device 11 for tempering the metallic sheet material 7a. In this way, it is also possible to coat very thin-layer metal foils, in particular copper foils, whose melting point is below the usually prevailing temperatures in the second temperature zone 4 of reactor 2, with nano- or microstructured silicon carbide foams 9 without melting and without damage.

The subject-matter of the present invention is illustrated in the following in a non-restrictive manner using examples.

### Working Examples

A mixture of tetrachlorosilane and butane is sprayed into the upper half of an argon-filled reactor at temperatures of 1,300 and 1,800° C. in the upper half of the reactor.

In the lower half of the reactor, the temperatures are between 1,100 and 1,300° C. The reactor, in particular the gas chamber, is heated by means of a microwave field.

A copper foil is moved through the second, lower temperature zone of the reactor at a feed rate of 0.1 m/s. The copper foil has a width of approx. 10 cm and is in the form of a copper strip. The copper foil is maintained at temperatures between 800 and 950° C. by means of a separate tempering device. While the copper foil is moved through the reactor, a nano- or micro-structured silicon carbide foam is deposited on its surface on an area of 30×10 cm. At the selected feed rate of 0.1 m/s, this leads to the formation of a 10 μm thick layer of silicon carbide foam.

FIG. 3 shows 100× the magnification of a silicon carbide foam produced using the inventive process. It shows that there is indeed a highly porous foam structure which is excellently suited as an anode material for lithium ion accumulators.

FIG. 4 shows an excerpt of the silicon carbide foam produced with the method according to the invention at 35,000× magnification. At this magnification, it is easy to see that the silicon carbide foam is an open-cell foam composed of individual silicon carbide fibers which are cross-linked with each other.

### REFERENCE SIGNS

1 Apparatus
2 Reactor
3 First temperature zone
4 Second temperature zone
5 Precursors
6 Introduction device
7 Substrate
7a Sheet material
8 Heating device
9 Silicon carbide foam
10 Sluice device
11 Tempering device

1. Method for producing silicon carbide-containing fibers or silicon carbide-containing nano- and/or microstructured foams,
characterized in that
(a) introducing precursors containing at least one carbon source and at least one silicon source a first temperature zone, of a reactor heated to temperatures in the range from 1,300 to 2,100° C. so that the precursors are decomposed, and
(b) depositing in a second temperature zone; of the reactor, silicon carbide-containing fibers and/or silicon carbide-containing nano- or microstructured foams on a substrate.

2. Method according to claim 1, the silicon carbide-containing fibers and the silicon carbide-containing nano- and/or micro-structured foams include doped nanocrystalline silicon carbide.

3. Method according to claim 1, wherein the silicon carbide-containing fibers and the silicon carbide-containing nano- or micro-structured foams consist of non-stoichiometric silicon carbide or silicon carbide alloys.

4. Method according to claim 1 wherein a temperature gradient is present in the reactor between the first and the second temperature zones of the reactor.

5. Method according to claim 1, wherein the temperature is lower in the second temperature zone of the reactor than in the first temperature zone of the reactor.

6. Method according to claim 5, wherein the temperature in the second temperature zone of the reactor is set to a temperature lower than in the first temperature zone of the reactor wherein the temperature set lower is selected from the group consisting of at least 30° C. lower, at least 40° C. lower, and at least 50° C. lower.

7. Method according to claim 1, wherein the precursors are carbon and silicon sources having a form selected from the group consisting of liquids, gases, solutions, dispersions, precursor sols, and mixtures thereof.

8. Method according to claim 7, wherein the precursors further comprise at least one doping reagent.

9. Method according to claim 1, wherein the precursors are introduced as a fine distribution into the reactor.

10. Method according to claim 1 wherein the substrate is selected from the group consisting of metal substrates, graphite substrates, carbon nanotubes, carbon fiber-reinforced plastic panels, ceramic substrates, silicon carbide substrates and mixtures thereof.

11. Method according to claim 1, wherein the temperatures in the first temperature zone of the reactor are set to 1,500 to 2,100° C.

12. Method according to claim 1, wherein for producing the silicon carbide-containing fibers, the temperature in the second temperature zone of the reactor is set to 50 to 300° C. lower than in the first temperature zone of the reactor.

13. Method according to claim 1, wherein, the temperatures in the first temperature zone of the reactor are set to 1,100 to 1,800° C.

14. Method according to claim 1, wherein the temperature in the second temperature zone of the reactor is set to 30 to 200° C. lower than in the first temperature zone of the reactor.

15. Silicon carbide-containing fibers obtainable by a method according to claim 1.

16. A composite material selected from the group consisting of a lightweight construction material, a laminated glass, and a reinforcing filler, the composite material including silicon carbide fibers prepared according to claim 15.

17. An anode material including silicon carbide fibers prepared according to claim 15

18. Silicon carbide-containing nano- and/or microstructured foams, obtainable by a method according to claim 1.

19. Articles including silicon carbide-containing nano- and/or microstructured foams prepared according to claim 18, the articles selected from the group consisting of seals, suspensions, spring stanchions, dampings, insulations, membranes, and filters.

20. A member including a silicon carbide-containing nano- and/or microstructured foam prepared according to claim 18, wherein the member is selected from the group consisting of an electrode, an anode, and an anode material.

21. An apparatus for producing silicon carbide-containing materials selected from the group consisting of fibers, nano-foams, and microstructured foams,
wherein the apparatus comprises
(a) at least one reactor comprising
(i) a first temperature zone; and
(ii) a second temperature zone,
wherein the temperatures in the first and second temperature zones, are controllable independently of one another by a control unit,
(b) at least one introduction device, for introducing, gaseous and/or liquid precursors, containing at least one carbon source and at least one silicon source, into the first temperature zone of the reactor; and
(c) at least one substrate in the second temperature zone of the reactor for depositing the silicon carbide-containing fibers and/or the silicon carbide-containing nano- or microstructured foams.

22. Apparatus according to claim 21, characterized in that the temperature in the first temperature zone is controllable in the range from 1,100 to 2,100° C.

23. Apparatus according to claim 21, characterized in that a temperature gradient between the first and the second temperature zone is settable, in particular wherein the temperature in the second temperature zone can be set lower than in the first temperature zone.

24. Apparatus according to claim 21, wherein the reactor comprises at least one heating device in the region of the first temperature zone.

25. Apparatus according to claim 21, wherein the reactor comprises at least one transport device for transporting the substrate, through at least a portion of the reactor.

26. Apparatus according to claim 21, further comprising a tempering device for tempering the substrate.

27. Method for applying a nano- or microstructured silicon carbide foam to a sheet material for producing an electrode,
characterized in that
(a) introducing precursors containing at least one carbon source and at least one silicon source into a first temperature zone of a reactor heated to temperatures sufficient to decompose the precursors, and
(b) depositing, in particular in a second temperature zone, of the reactor, a nano- or microstructured silicon carbide foam on a sheet material.

28. Method according to claim 27, wherein the temperatures in the first temperature zone of the reactor are set to 1,200 to 1,600° C.

29. Method according to claim 27, wherein the temperature in the second temperature zone of the reactor is set to 30 to 200° C. lower than in the first temperature zone of the reactor.

30. Method according to claim 29, wherein the sheet material consists of a material selected from the group consisting of, a ceramic material, a graphite material and at least one metal material.

31. Method according to claim 27, wherein the sheet material is a metallic sheet material selected from the group consisting of a metal sheet and a metal foil.

32. Method according to claim 27, wherein the sheet material has a thickness of 1 to 1,000 μm.

33. Method according to claim 27, wherein the sheet material is in the form of a strip selected from the group consisting of a graphite strip and a metal strip.

34. Method according to claim 27, wherein the sheet material is moved through the reactor.

35. Method according to claim 27, wherein the sheet material is tempered in the reactor to temperatures in the range from 700 to 1,000° C.

36. An electrode obtained by the process of claim 27.

37. Electrode prepared according to claim 27 comprising a sheet material and a nano- or micro-structured silicon carbide foam.

38. Lithium ion accumulator comprising an electrode according to claim 36.

39. Apparatus for applying a nano- and/or microstructured silicon carbide foam to a sheet material for producing an electrode,
wherein the apparatus comprises
(a) at least one reactor further comprising
(i) a first temperature zone; and
(ii) a second temperature zone,
wherein the temperatures in the first and second temperature zones are controllable independently of one another by a control unit,
(b) at least one introduction device for introducing precursors selected from the group consisting of a solid precursor, a liquid precursor, and a gas precursor, the precursors containing at least one carbon source and at least one silicon source and, optionally, doping reagents, into the first temperature zone of the reactor and
(c) at least one transport device for moving a sheet material through the reactor including the second temperature zone of the reactor, and/or a tempering device for tempering the sheet material.
